(19) United States
(12) Patent Application Publication
(10) Pub. No.: US 2015/0090532 A1
(43) Pub. Date: Apr. 2, 2015

(54) COLLAPSIBLE ESCAPE LADDER WITH GUARDS

(71) Applicant: SORLANDSSTIGEN AS, Larvik (NO)

(72) Inventor: Kjetil Engvoldsen, Larvik (NO)

(21) Appl. No.: 14/395,014

(22) PCT Filed: Apr. 15, 2013
(86) PCT No.: PCT/NO2013/050066

§ 371 Date: Oct. 16, 2014

(30) Foreign Application Priority Data
Apr. 19, 2012 (NO) 20120457

(51) Int. Cl. E06C 1/383; E06C 7/18

(52) U.S. Cl. CPC E06C 1/383; E06C 7/185
USPC 182/112; 182/159

(57) ABSTRACT

A collapsible escape ladder, including a first upright, a second upright, and a plurality of elongated rungs that extend between the first and second uprights and that are rotatably attached to the first and second uprights about a first and second rotation axis, respectively, that extend perpendicular to a ladder plane spanned by the first and second uprights and the rungs. The ladder has a closed state where the rungs are substantially hidden between the uprights and an open state where the rungs extend between the uprights and perpendicular to a building wall and wherein the ladder extends downward from an escape point to the ground. The ladder further comprises a plurality of rigid, elongated guard profiles extending parallel to the rungs, and each guard profile is connected to the uprights through a first side profile between one end of the guard profile and the first upright and a second side profile between the other end of the guard profile and the second upright, and wherein the guard profile is moveable from a position adjacent the rungs in the closed state to a position at a distance perpendicular to the ladder plane in the open state.

### CROSS-REFERENCE TO RELATED APPLICATIONS

This application is a 35 U.S.C. §371 national stage application of PCT/NO2013/050066 filed Apr. 15, 2013, and entitled “Collapsible Escape Ladder with Guards,” which claims priority to Norwegian Application No. 20120457 filed Apr. 19, 2012, both of which are incorporated herein by reference in their entirety for all purposes.

### BACKGROUND

1. Field of the Invention

The present invention concerns a collapsible escape ladder.

2. Prior and Related Art

Escape ladders or escape stairs are often mounted on the outside of buildings as escape routes, e.g. in case of fire. Permanently open ladders or stairs are obtrusive, and may disturb or ruin the appearance of a building.

There are known collapsible escape ladders which in their closed state appear as an unobtrusive moulding on an exterior wall. Such a ladder may comprise a first upright attached to the wall and coupled to a second, moveable upright by a plurality of hinged rungs of equal length forming parallelogram couplings. In the closed state, the uprights are latched adjacent to each other, e.g. by a latching pin, and the rungs are hidden between the uprights. When the latch is released, the second upright can swing out from the wall until the rungs are horizontal. The escape ladder is then in its open state and extends from an escape point accessible from e.g. a window or a balcony, to the ground.

A problem with most prior art escape ladders of the above type is that they lack guards or other safety means preventing a user from falling out and away from the ladder. Regulations making such fall safety mandatory are expected. Currently, the problem is mainly addressed by fixed escape ladders or fixed external escape stairs with railings or guards.

GB 191201752 discloses a collapsible escape ladder of the above kind with an additional foldable guard. The foldable guard comprises further uprights connected by cross members. An auxiliary ladder is provided in a normally withdrawn position unaccessible from the ground in order to prevent burglars etc. from entering via the ladders, and the escape is therefore provided with means for automatic release of the auxiliary ladder when released. The foldable ladder is preferably held in its folded position by springs, and the rungs are preferably parallel to the wall during use due to the design of the auxiliary ladder. The resulting foldable ladder is quite large when folded and mechanically complex. Also, brackets on the wall to receive the unfolded uprights and rungs are aesthetically disturbing elements.

The objective of the present disclosure is to provide an improved collapsible escape ladder with guards that prevent the user from falling out from the ladder while retaining the benefits of known escape ladders.

### SUMMARY OF THE INVENTION

According to the disclosure, this is achieved by a collapsible escape ladder with a first upright, a second upright and several elongated rungs which extend between the uprights and are rotatably attached to the uprights about rotation axes that extend perpendicular to a ladder plane spanned by the uprights and the rungs. The ladder has a closed state wherein the rungs are substantially hidden between the uprights and an open state wherein the rungs extend perpendicular to a building wall between the uprights and wherein the ladder extends downward from an escape point to the ground. The escape ladder further comprises a plurality of rigid, elongated guard profiles extending parallel to the rungs, wherein each guard profile is connected to the uprights through a first side profile between one end of the guard profile and the first upright and a second side profile between the other end of the guard profile and the second upright, and wherein the guard profile is moveable from a position adjacent the rungs in the closed state to a position at a distance perpendicular to the ladder plane in the open state.

The ladder thus gets a plurality of guards, each comprising a guard profile connected to the uprights through side profiles. In the closed state, the guards are completely or partly hidden by the uprights. In the open state, the guards are distributed along the ladder between escape point and ground so that users cannot fall away from the ladder.

In one embodiment, the guard profile is biased out from the ladder plane. Thus, the guard profile is pushed out from the ladder plane when the ladder swings out to its open state.

The side profiles can be attached to the uprights through a rung and the rotation axes of the rung. Thereby, the number of rotation axles can be decreased. Alternatively, each side profile is swingable connected with its respective upright about a separate rotation axis extending parallel to the rotation axes of the rungs and perpendicular to the ladder plane.

Each side profile can comprise a proximal elongated side beam which at a proximal end is turnable attached at its respective upright about a first turning axis and at a distal end is turnable attached to a distal elongated side beam about a second turning axis. The distal side beam extends from adjacent the second turning axis to the guard profile where it is turnably attached about a third turning axis extending parallel to the first and second turning axes parallel to the ladder plane and perpendicular to the rotation axes. In other words, each side profile is a joint comprising a proximal and a distal side beam. The elements are turnable connected about turning axes that extend at right angles to the plane spanned by the guard profile and the side profiles.

In this embodiment, the distance between the middle, i.e. second, turning axes is preferably less than the distance between the first turning axes and less than the distance between the third turning axes. Thereby, the guard folds neatly when a force is exerted on the guard profile toward the ladder plane.

This embodiment with jointed side profiles may further comprise a guide which, viewed in the direction toward the ladder plane, taper up and in toward a symmetry plane between the side profiles, and which engages a side face on at least one of the proximal side beams facing away from the symmetry plane, whereby the proximal side beam is turned about the first turning axis in toward the ladder plane when the second upright is swung up from the open state to the closed state. As an alternative to the jointed side profiles, the side profiles can comprise telescopically connected side beams.

In a preferred embodiment, each side profile is a single, rigid beam pivoted in the upright about a pivot axis parallel to the rungs. Thus, in the closed state, the guard is pivoted adjacent the ladder plane and in the open state the guard can be pivoted to span a plane extending parallel to the horizontal rungs and perpendicular to the ladder plane. This embodiment merely requires a bracket with two axes perpendicular to each other, e.g. an angle iron with perpendicular bores for rotation and pivot axles, between the upright and the side profile. In this embodiment, gravity may cause the second upright to swing out and brining about rotation about the rotation axes. At the same time, gravity may cause the rigid guards to pivot out to their open positions. Thus, the number of extra parts such as springs, side beams and couplings is kept at a minimum.

In some embodiments, the uprights may have longitudinal guides with stoppers and the side profiles are slidably attached in the guides, whereby the guard profiles with their respective side profiles are deployed at the top of the ladder in the closed state and are distributed along the ladder between the escape point and the ground in the open state.

Preferably, a safety net is connected to the guards such that a user is prevented from falling out between two guards when escaping down the ladder.

The said embodiments can be combined with each other.

In all embodiments the ladder has, in its open state, a plurality of guards distributed along the length between the escape point and the ground wherein each frame is formed of a guard profile and two side profiles connecting it to the uprights preventing a user from falling away from the ladder. A safety net spanned by the guards enhances this functionality. Further, the ladder and guards can be brought to the open state automatically upon a simple release, such as removal of a locking pin.

### BRIEF DESCRIPTION OF THE DRAWINGS

The invention is described in greater detail below with reference to the accompanying drawings, wherein:

FIG. 1a shows a first embodiment of the escape ladder in a partly open state viewed perpendicular to the ladder plane,

FIG. 1b shows the ladder in FIG. 1a seen from above,

FIG. 2a shows the ladder in FIG. 1a in its open state seen perpendicular to the ladder plane

FIG. 2b shows the ladder on FIG. 1a in its open state viewed from above,

FIG. 3 illustrates a second embodiment of a side profile,

FIG. 4 illustrates a third embodiment, and

FIG. 5 illustrates a fourth embodiment.

### DETAILED DESCRIPTION

The figures are schematic views and are not necessarily to scale.

Throughout this description and the claims, the term “rotation axis” denotes an axis perpendicular to the ladder plane. When the ladder is swung from its closed to its open state, it swings in the (vertical) ladder plane and the ends of the rungs swings around rotation axes. A “turning axis” denotes an axis perpendicular to a rung and parallel to the ladder plane. Thus, in the open state, the turning axes are vertical. A “pivot axis” denotes an axis parallel to the rungs, i.e. an axis which is horizontal and parallel to the ladder plane when the ladder is in its open state. Axles implementing these axes are given similar names where mentioned. However, as a pivot may be implemented by means other than axles, and e.g. a rung may double as a pivot axle, the term axis is preferred over the term axle, and is intended to imply any means permitting a relative rotation between two members.

In all embodiments below, it is understood that the ladder 100 has an open state wherein the ladder extends from an escape point to the ground and a plurality of guards are distributed along the ladder between the escape point and the ground such that users are prevented from falling away from the ladder. In a closed state, the rungs 103 and guards are completely or partly hidden, usually within uprights 101 and 102. Each guard consists of two side profiles 110, 120 which in the open state extend horizontally from the two uprights 101, 102 to which the rungs 103 are attached, each side profile 110, 120 to a respective end of a guard profile 104.

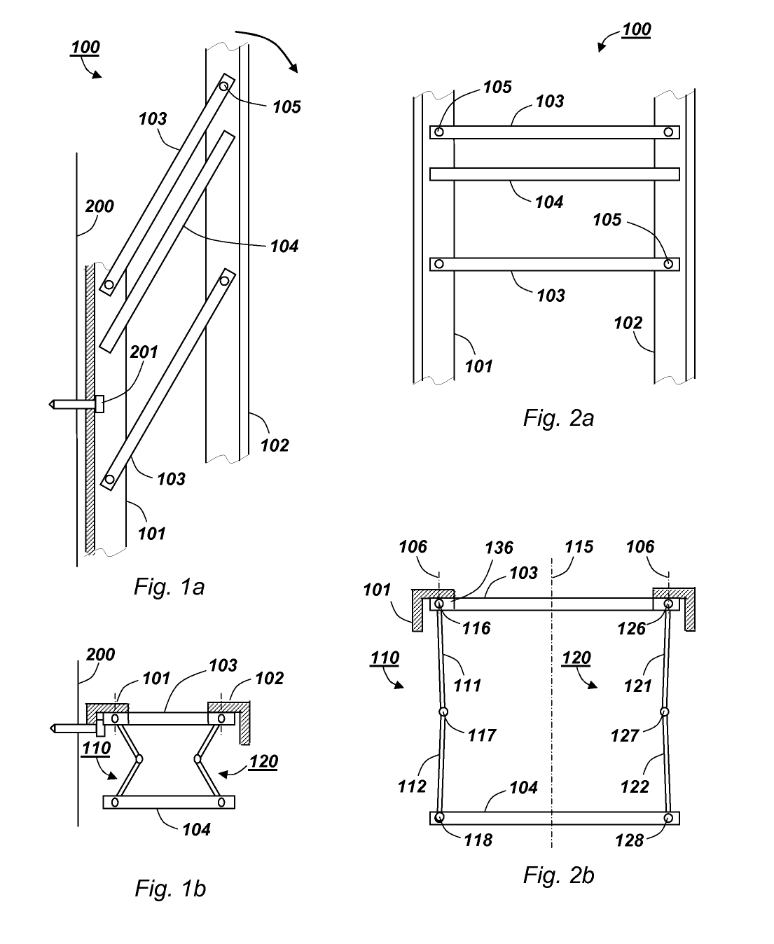

FIG. 1a shows a first embodiment of an escape ladder 100 in a partly open state viewed perpendicular to the ladder plane spanned by a first upright 101, a second upright 102 and a plurality of rungs 103. The first vertical upright 101 is attached to an outer wall 200 and is shown partly cut through. The bolt 201 represents all known attachment means. Spacers provided to dispose the ladder outside protrusions and the like are known to one skilled in the art, and are not shown in the drawings. It is assumed that the ladder is deployed such that a release mechanism, for example a locking pin keeping the ladder in a closed state, is available from an escape point, for example a window or balcony, and that the ladder in a simple manner can be opened to an open position where it extends from the escape point to the ground. Stoppers prevent the ladder from swinging past an operational position where the rungs of the ladder are perpendicular to the uprights. These and other features apparent to one skilled in the art are omitted from the drawings for clarity.

In order to enable the ladder to swing from its closed state (not shown) to its open state (FIG. 2), each rung 103 of the ladder is rotatably attached to the uprights 101, 102 through rotation axles 105 extending perpendicular to the ladder plane. The ladder is oriented perpendicular to the building wall when open. The rotation axes 105 in each end of the rungs 103 are in this case horizontal and extend parallel to the housewall.

In the embodiment on FIGS. 1 and 2 a plurality of rigid, elongated guard profiles 104 run parallel to the rungs 103. Only one guard profile 104 is shown in FIGS. 1 and 2. If the guard profiles 104 are to be attached to the uprights 101, 102, they must be able to rotate about rotation axes in the same manner as the rungs 103. In the embodiment shown, the guard profile 104 is displaced from the rungs 103 (FIGS. 1a, 2a), and thus have separate rotation axes 106 (FIG. 2b) that are parallel to the rotation axes 105 of the rungs. In an alternative embodiment, a guard profile 104 can be attached to a rung 103, in which case it shares the rotation axes 105 with the rung 103.

Each guard profile 104 is moveable away from the ladder plane from a closed state in which it, for example, can be hidden within the uprights to provide a neat appearance, to an open state in which it forms a guard together with side profiles 110, 120. In some embodiments, the guard profile 104 can be biased out from the ladder plane, for example by a spring, such that the guard profile is forced out from the ladder plane by a spring force. In other embodiments disclosed below, the guards can fall into position in the open state due to a gravitation force acting on them. Stoppers preventing the guard from folding out before the ladder is folded out are known to one skilled in the art, and are neither shown in the drawings nor further disclosed herein.

In the first embodiment shown in FIGS. 1 and 2 the side profiles 110, 120 are provided as joints that are symmetric about the symmetry plane 115 (FIG. 2b). The first joint 110 consists of a proximal, elongated side beam 111 which at a proximal end is turnable attached at the first upright 101 through a first turning axle 116. The turning axle 116 is perpendicular to the rotation axes 105, 106 and extends into the paper plane on FIG. 2b. The side beam 111 is in an opposite, i.e. a distal end, turnable attached to a distal elongated side beam 112 through a second turning axle 117 parallel to the first turning axle 116. The distal side profile 112 extends from the second turning axle 117 to a first end of the guard profile 104, where it is attached through a third turning axle 118. The second joint 120 has similar proximal (121) and distal (122) side profiles extending between the second upright 102 and the other end of the guard profile, and which are connected by first, second and third turning axles 126, 127 and 128. All turning axles 116-118, 126-128 have axes extending parallel to the ladder plane and perpendicular to the rotation axes 105, 106 and which are substantially vertical when the ladder 100 is in its open state (FIG. 2b).

A bracket 136 with two axes perpendicular to each other, e.g. the axes through the rotation axle 106 and the first turning axle 116 shown in FIG. 2b, can be made of an angle iron with bores for the respective axles. This and similar connections are known to one skilled in the art, and are not further described.

It is understood that the side beams 111, 112, 121 and 122 in this and other embodiments can be made in any suitable form and dimension, e.g. as a cylindrical rod, a plate formed member or an extruded profile having a suitable cross-section. Further, the bias can for instance be provided by a leaf spring disposed at the turning axis 117 which is configured to force the side beams to the position depicted in FIG. 2b.

From FIG. 2b, it appears that the distance between the other turning axes 117 and 127 is less than the distance between the first 116, 126 turning axes and less than the distance between the third 118, 128 turning axes. This gives an inward bend toward the symmetry plane 115, such that the joints 110, 120 fold in the desired direction when the ladder is closed to the closed state.

When the side profiles are joined as in FIGS. 1 and 2, a guide may be provided to fold at least one of the joints 110, 120 when the upright 102 is lifted. Such a guide can have a face engaging one 111 and/or second 121 proximal side profile on the sides facing away from the symmetry plane 115, forcing the side profiles toward each other when the upright 102 is lifted from the position shown in FIG. 2a. Viewed in the direction toward the ladder plane, this face or guide taper up and in toward the symmetry plane 115. Similar guides can be designed for other embodiments described herein such that the ladder can be brought from the open to the closed state. The guides may also comprise lines or wires.

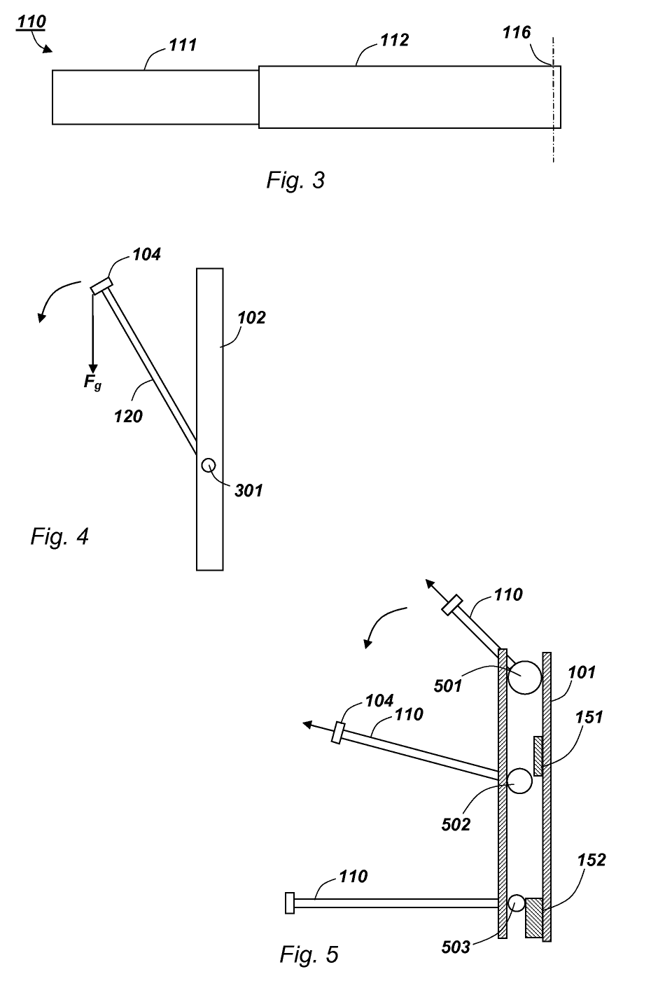

FIG. 3 shows an alternative embodiment of the side profile 110 wherein the side beam 112 is slidably disposed in the side beam 111 in a telescopic coupling. It is understood that more elements than the beams 111 and 112 can be put together with similar telescopic couplings and that the elements can be biased, for example by one or more springs. A first turning axis 116 to show that this embodiment can be combined with the first embodiment shown in FIGS. 1 and 2. Connection to the uprights through rotation axes 105 or 106 and other features disclosed above are applicable with necessary adaptations also the embodiment on FIG. 3. It is also clear that the side profile 120 can be made in the same manner as the side profile 110.

FIG. 4 shows an embodiment wherein a side profile 120 is rotatable connected to a upright 102 through a pivot axis 301 at one of its ends and to the guard profile 104 at its other end. In this embodiment the guard profile is moved out from the ladder plane to the open state by the guard profile 104 and side profile 104 rotates about the pivot axis 301. The movement is illustrated by the curved arrow in FIG. 4. The gravitation force pulling the guard profile 104 to the open state is illustrated by the arrow F_{g}. The profiles 102, 104 and 120 is as on the previous figures, and the pivot axis 301 is perpendicular to the rotation axes and the turning axes when the ladder 100 is open. Thus, in the open state, the pivot axis 301 is horizontal and parallel to the ladder plane, while the turning axes 116, 117 etc are vertical and parallel to the ladder plane also when the ladder is open.

FIG. 5 illustrates an escape ladder wherein the uprights 101, 102 have longitudinal guides and the side profiles 110, 120 is slidably attached to the guides, whereby the guard profiles with their respective side profiles can be disposed at the top of the ladder when the ladder is in its closed state and slides down the ladder when the ladder is swung to its open state or when the ladder is open. FIG. 5 merely shows a section through a hollow upright 101, wherein side profiles 110 slide downward while they are substantially kept from moving in the horizontal direction by sliding elements, here illustrated by spheres 501, 502, 503. Stoppers 151, 152 illustrates schematically that a small sliding element can pass through a smaller aperture than a large sliding element. The largest sliding sphere 501 is stopped by the stopper 151, while the spheres 502 and 503 having smaller diameters pass. The second largest sphere 502 is stopped by the stopper 152, while the sphere 503, having smaller diameter, is stopped further down. Guards attached in this manner can be released from the top when the ladder 100 is folded out and stop at predetermined locations. In open condition the ladder thereby gets several guards distributed between the escape point and the ground preventing the user from falling away from the ladder.

FIG. 5 is also illustrates that the embodiments above can be combined. The arrows in the extension of the side profiles 110 is intended to show that the guard profile 104 can be biased and be moved away from the ladder plane as discussed in connection with FIGS. 1-3. The different angles between the side profiles 110 and the ladder plane, here represented by the upright 101, are intended to illustrate the embodiment described with reference to FIG. 4. These embodiments and the embodiment where the guards are released from the top of the ladder when it is open can thus be used separately or in combination with each other.

In a preferred embodiment, the guards, each comprising a guard profile 104 and two side profiles 110 and 120, are connected by a net or fabric such that a person cannot fall away from the escape ladder between two guards.

While the invention has been described with reference to exemplary embodiments, the invention is fully defined by the attached claims.

1. A collapsible escape ladder, comprising:
a first upright;
a second upright; and
a plurality of elongated rungs that extend between the first and second uprights and that are rotatably attached to the first and second uprights about a first and second rotation axis, respectively, that extend perpendicular to a ladder plane spanned by the first and second uprights and the rungs;
wherein the ladder has a closed state where the rungs are substantially hidden between the uprights and an open state where the rungs extend between the uprights and perpendicular to a building wall and wherein the ladder extends downward from an escape point to the ground;
wherein the ladder further comprises a plurality of rigid, elongated guard profiles extending parallel to the rungs, wherein each guard profile is connected to the uprights through a first side profile between one end of the guard profile and the first upright and a second side profile between the other end of the guard profile and the second upright, and wherein the guard profile is moveable from a position adjacent the rungs in the closed state to a position at a distance perpendicular to the ladder plane in the open state.

2. The escape ladder according to claim 1, wherein the guard profile is biased out from the ladder plane.

3. The escape ladder according to claim 1, wherein the side profiles are attached to the uprights through a rung and the rotation axes of the rung.

4. The escape ladder according to claim 1, wherein each side profile swingably connected with its respective upright about a rotation axis extending parallel to the rotation axes of the rungs and perpendicular to the ladder plane.

5. The escape ladder according to claim 1, wherein each side profile comprises a proximal elongated side beam which at a proximal end is turnable attached at its respective upright about a first turning axis and at a distal end is turnable attached to a distal elongated side beam about a second turning axis, wherein the distal side beam extends from adjacent the second turning axis to the guard profile where it is turnably attached about a third turning axis extending parallel to the first and second turning axes parallel to the ladder plane and perpendicular to the rotation axes.

6. The escape ladder according to claim 5, wherein the distance between the second turning axes is less than the distance between the first turning axes and less than the distance between the third turning axes.

7. The escape ladder according to claim 5, further comprising a guide which, viewed in the direction toward the ladder plane, tapers up and in toward a symmetry plane between the side profiles, and which engages a sideface on at least one of the proximal side beams facing away from the symmetry plane, whereby the proximal side beam is turned about the first turning axis in toward the ladder plane when the second upright is swung up from the open state to the closed state.

8. The escape ladder according to claim 1-4, wherein the side profiles comprise telescopically connected side beams.

9. The escape ladder according to claim 1, wherein at least one side profile is pivoted in the upright about a pivot axis parallel to the rungs.

10. The escape ladder according to claim 1, wherein the uprights have longitudinal guides with stoppers and the side profiles are slidably attached in the guides, whereby the guard profiles with their respective side profiles are deployed at the top of the ladder in the closed state and are distributed along the ladder between the escape point and the ground in the open state.

11. The escape ladder according to claim 1, further comprising a safety net around the guards.
